(19) United States
(12) Patent Application Publication
(10) Pub. No.: US 2008/0035826 A1
(43) Pub. Date: Feb. 14, 2008

(54) Pole-type member support device and method therefor

(76) Inventors: Edgardo Clores, Las Vegas, NV (US); Hiuel J. Ceria, Las Vegas, NV (US)

Correspondence Address: WEISS & MOY PC, 4204 NORTH BROWN AVENUE, SCOTTSDALE, AZ, 85251, US

(21) Appl. No.: 11/500,729

(22) Filed: Aug. 8, 2006

(51) Int. Cl. F16M 13/00

(52) U.S. Cl. 248/523

(57) ABSTRACT

A pole-type member support device is provided. The pole-type member support device has a receptacle body with a lower portion including a bottom wall and an upper portion with a top wall defining an opening for receiving the pole-type member support device. A multi-sided sidewall extends between the bottom wall and top wall. A beveled lip may provide a transition surface between the upper and lower portions of the receptacle.

Inside the receptacle, a moveable support cooperates with an opposing fixed support to hold the pole-type member in an upright position in the receptacle. The top wall, moveable support and opposing fixed support are all substantially C-shaped with a multi-sided rear surface and a substantially V-shaped front opening. The substantially V-shaped opening serves as the gripping surface.

An adjustment pin with a plurality of apertures provided in a top surface thereof defining different positions for the moveable support member extends rearwardly from the moveable support through the adjacent sidewall. A fixing pin is adapted to be inserted into the desired aperture to position the moveable support member in the desired position. The fixing pin extends vertically through the adjacent sidewall.

The pole-type member support may also include a collapsible base member, an S-shaped base member or a base member that encases the receptacle body and resembles a Santa sack.

### RELATED APPLICATIONS

This application is related to Application Ser. No. 09/779408 filed Feb. 9, 2001 entitled POLE-TYPE MEMBER SUPPORT DEVICE AND METHOD THEREFOR (now abandoned) by one of the same named inventors and to three design patent applications entitled “ORNAMENTAL DESIGN FOR A TREE STAND” filed concurrently herewith by the same named inventors and are incorporated by reference.

### FIELD OF THE INVENTION

This invention relates generally to poles, trees and other elongated objects and more specifically to a pole-type member support device and method therefor for securely supporting poles, trees and other elongated objects in an upright position for an extended period of time.

### BACKGROUND OF THE INVENTION

During the holiday season, many people bring Christmas trees into their homes for both decorative and religious purposes. The Christmas trees often vary in height and size, creating varying degrees of difficulty in supporting the trees in a stable position. Other people purchase or rent trees, tiki torches or other pole-type items for special events and occasions. In these cases as well, it is difficult to support these items in a stable manner. Often, the result is that the trees, poles or other items are either leaned against a wall or propped up on some other unstable way. This lack of a proper support device can lead to a number of unwanted consequences ranging from a mess to severe physical injury. A tree falling from an unstable position can cause not only property damage but can also bring severe harm to a person. Likewise, a failing tiki torch or a pole-type item with a candle or other lit object on top could ignite a fire. In addition to the instability caused by a lack of support, a Christmas tree dries out over the course of the holidays posing a fire danger and its longevity is often limited because of the absence of water.

Previous attempts have been made to provide a support device for Christmas trees. For example, U.S. Pat. No. 5,970,655 issued to Freeman discloses a Christmas tree resting inside a collar member having a radial extension and a rod between the tree and the radial extension. The Freeman patent requires the attachment of a rod to a portion of the tree, a time-consuming and difficult process. Additionally, the Freeman patent does not provide a collar capable of being adjusted to the varying thickness of different trees or other pole-type members.

Accordingly, there has been a need for a pole-type member support device which is of simplified construction, and inexpensive to manufacture. Such a device is also needed which holds a pole-type member in a fixed relationship for an extended period of time. A device is also needed which permits watering if a tree is positioned in the device. A still further need exists for a pole member support device capable of being adjusted to securely support a tree or other pole-type member of varying degrees of thickness. The present invention fulfills these needs and provides other related advantages.

### SUMMARY OF THE INVENTION

A pole-type member support device for securing pole-type members of varying thickness in an upright position is provided, comprising a molded hollow receptacle body adapted to receive a portion of a pole-type member; a moveable support member and a spaced-apart opposing fixed support member within the molded hollow receptacle body for cooperatively holding the pole-type member upright in the receptacle body; and an adjustment assembly for positioning the moveable support member to accommodate pole-type members of varying thickness. The pole-type member support device may further comprise a base member.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective environmental view of a pole-type member support device embodying the invention, illustrating a Christmas tree secured in an upright position therein;

FIG. 2 is a perspective view of the pole-type member support device of FIG. 1, illustrating a molded receptacle body having a multi-sided sidewall and an opening in a top wall with the receptacle body supported on a base member with a rotatable brace thereof in an open position and an adjustment pin and cooperating fixing pin through one of the panels of the sidewall;

FIG. 3 is an operational perspective view of the pole-type member support device of FIGS. I and 2, illustrating the brace of the base member in a closed position with arrows indicating horizontal movement of the adjustment pin, and vertical movement of the cooperating fixing pin;

FIG. 4 is another operational perspective view of the pole-type member support device of FIGS. 1-3, illustrating in dotted lines moveable and fixed support members inside the receptacle body and the rotatable brace with a first and second (in dotted lines) stop member;

FIG. 5 is a perspective view of the pole-type member support device of FIGS. 1-4, illustrating the receptacle body and base member in dotted lines;

FIG. 6 is a perspective view of the pole-type member support device of FIG.4, illustrating in dotted lines the moveable and fixed support members cooperating to hold a pole (in dotted lines) in an upright position within the receptacle body and the base member in an open position;

FIG. 7 is another perspective view of the pole-type member support device of FIG. 4, illustrating in dotted lines the moveable and fixed support members cooperating to hold a tree trunk in an upright position within the receptacle body;

FIG. 8 is a top view of the pole-type member support device;

FIG. 9 is a side view of the pole-type member support device of FIG. 8;

FIG. 10 is a perspective view of an alternative embodiment of a pole-type member support device, illustrating a receptacle body having an substantially S-shaped base member;

FIG. 11 is a top view of the pole-type member support device of FIG. 10;

FIG. 12 is a top view of an alternative embodiment of a pole-type member support device, illustrating a base member in the form of a molded Santa sack shell encasing a receptacle body; and

FIG. 13 is a perspective view of the pole-type member support device of FIG. 12.

### DETAILED DESCRIPTION OF THE PREFERRED EMBODIMENTS

As shown in the drawings for purposes of illustration, the present invention is concerned with an improved pole-type member support device, generally designated in the accompanying drawings by the reference number 10. The pole-type member support device comprises, generally, a hollow receptacle body 12 adapted to receive a pole-type member 14, a moveable support member 16 and an opposing fixed support member 18 therein for cooperatively holding the pole-type member 14 upright in the receptacle body 12, and a pin adjustment assembly 20 for positioning the moveable support member 16 to accommodate pole-type members of varying thickness. The pole-type member support device may further comprise a base member 22, 122, or 222.

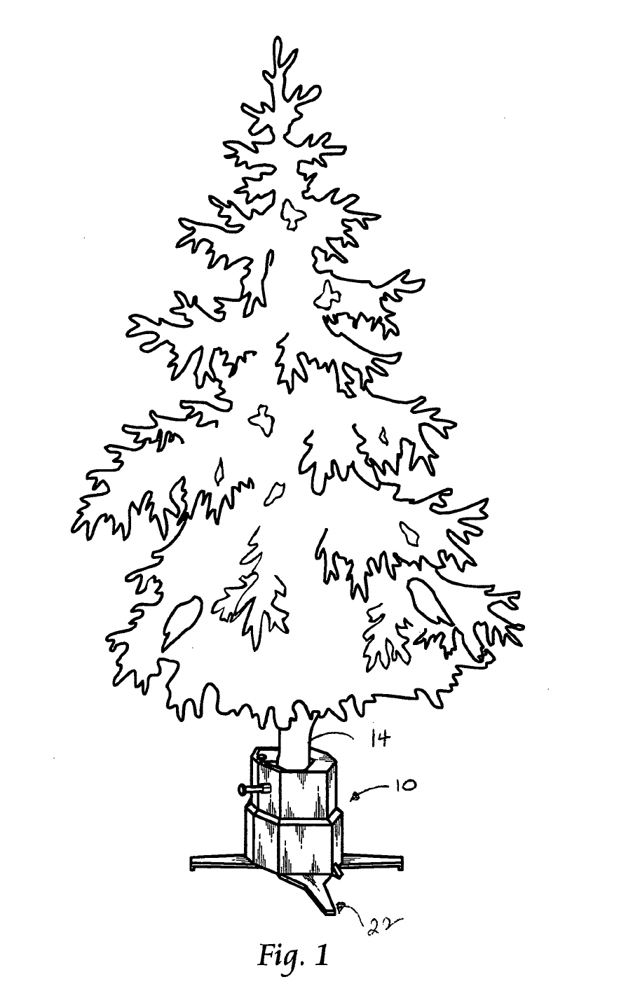

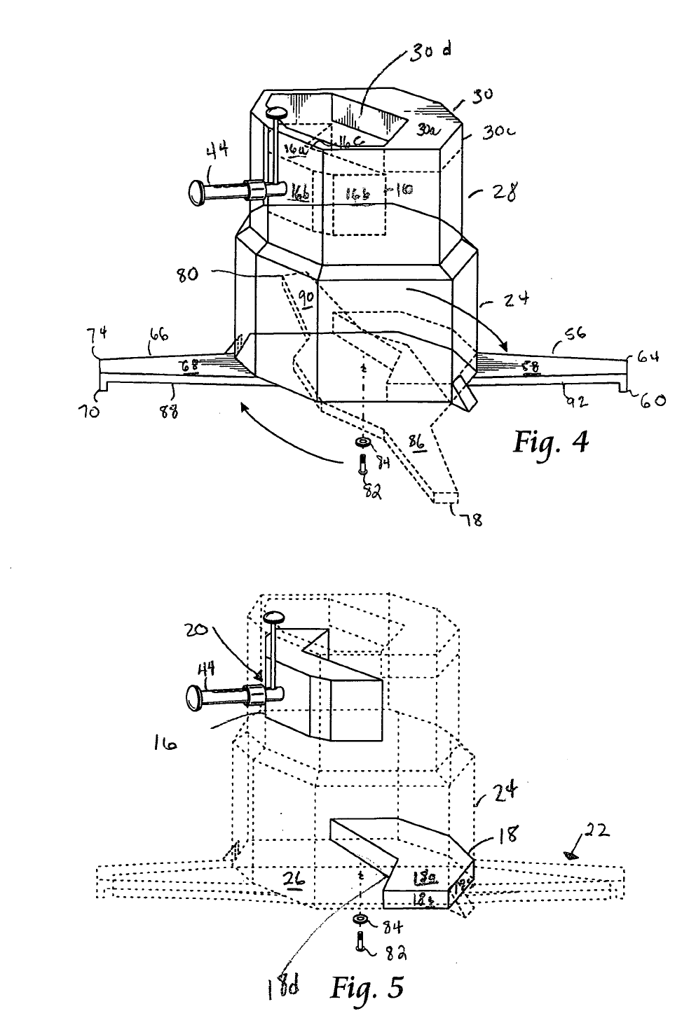

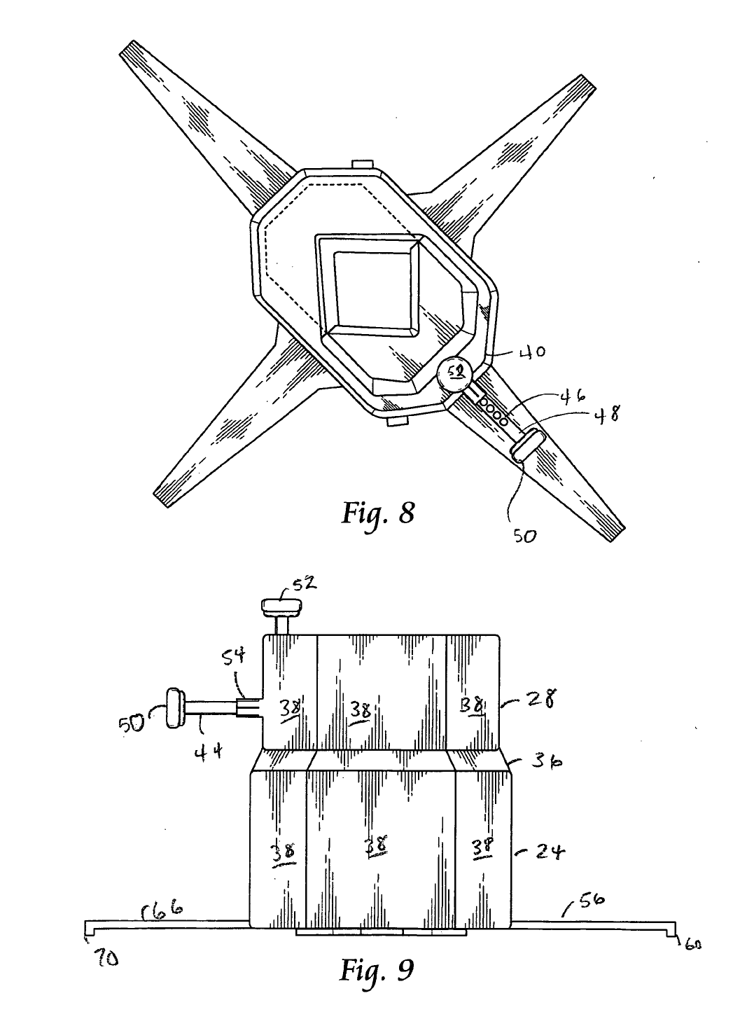

In accordance with the present invention, and as illustrated with respect to a preferred embodiment in FIGS. 1 through 13, the improved pole-type member support device 10 is configured for stable placement on a surface to hold a pole-type member, including a Christmas tree or the like, upright for an extended period of time. The improved pole-type member support may be dimensioned to contain water to keep the tree hydrated during is positioning in the device.

Referring to FIGS. 1-5, the receptacle body 12 has a lower portion 24 including a bottom wall 26 (FIG. 5) and an upper portion 28 with a top wall 30 defining an opening 32 therein and a multi-sided sidewall 34 extending between the bottom wall 26 and the top wall 30 of the receptacle body 12. The lower portion 24 may have a larger circumference than the upper portion. A beveled lip 36 may provide the transition surface between the lower and upper portions 24 and 28. As illustrated, the multi-sided sidewall 34 is formed by a plurality of panels 38 positioned in a side-by-side relationship about the periphery of the sidewall. Each pair of adjacent panels interconnect at an angle. The number of panels utilized to form the sidewall can vary.

The top wall 30 extends over the top of a portion of the receptacle body 12 to define an opening for receiving the pole-type member 14. The top wall 30 may be substantially C-shaped with a top surface 30a, a bottom surface (not shown), a multi-sided rear surface 30b adjoining an upper end of a plurality of sidewall panels and a substantially V-shaped opening (or cutout) 30c in the front thereof for an inner gripping surface. The number of sides of the rear surface 30b corresponds to the number of adjoining sidewall panels. The substantially V-shaped opening 30c defines a portion of the opening 32 defined in the top wall 30 of the receptacle body 12.

The sidewall panel opposite the vertex of the substantially V-shaped opening of the top wall may include an outwardly bowed section 40, as formed, to accommodate a fixing pin 42 as hereinafter described.

The receptacle body 12 and fixed and moveable support members may be blow molded or the like from a hard plastic to provide a substantially stable base able to support the weight and height of the pole-type member as well as the weight of the water, if used. The material used may be substantially waterproof to contain water for an extended period of time. A suitable plastic material may be polyethylene plastic or the like.

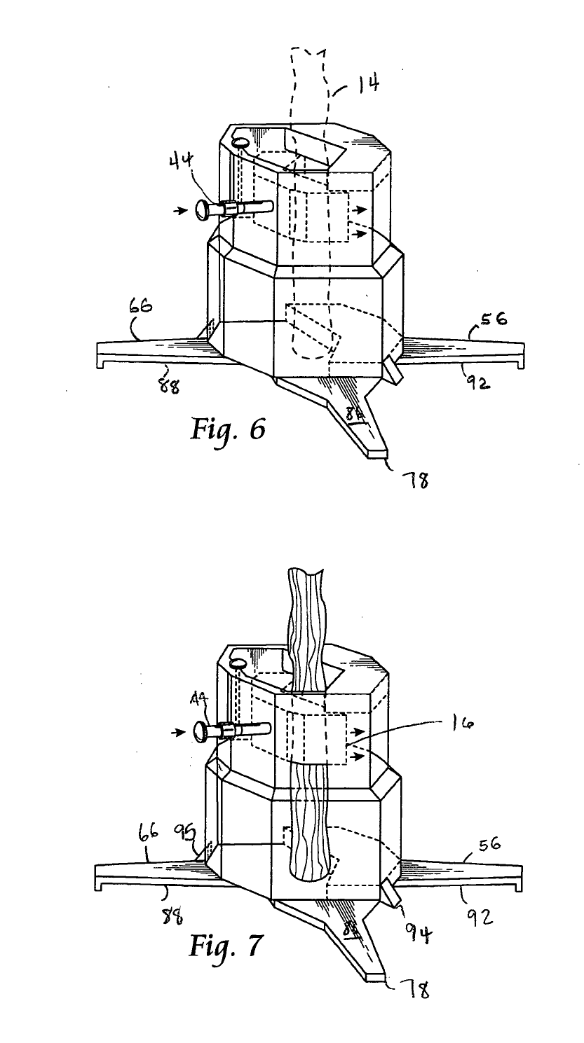

The moveable support member 16 has substantially the same shape as the top wall 30. The substantially C-shaped moveable support member 16 has a top surface 16a, a bottom surface (not shown), a rear surface 16b adapted to abut the sidewall panels and a substantially V-shaped opening 16c in the front thereof for use as an inner gripping surface. The moveable support member 16 may be spaced immediately below and opposite the top wall 30 in the upper portion 28 of the receptacle body 12. An adjustment pin 44 as hereinafter described extends rearwardiy from the middle panel of the rear surface 16b of the moveable support member 16 through the adjacent sidewall panel as shown in FIG. 6.

The pin adjustment assembly 20 permits manual adjustment of the moveable support member 16. The pin adjustment assembly comprises the adjustment pin 44 with a plurality of apertures 46 provided in a top surface thereof 48 defining different positions for the moveable support member 16, and the fixing pin 42 adapted to be inserted downwardly inside the same sidewall panel through which the adjustment pin extends into the desired aperture 46 to position the moveable support member 16 in the desired position. The adjustment pin 44 and the fixing pin 42 may each have a knob 50 and 52, respectively, at a free end for easier handling. The positioning of the moveable support member 16 may be adjusted by horizontal movement of the adjustment pin 44 and repositioning the fixing pin 42 relative to the receptacle body 12 by repositioning the fixing pin in the desired aperture. The repositioning is used to accommodate pole-type members of varying thickness, and to adjust the gripping tension on the pole-type member. The adjustment pin and fixing pin may be spring-biased, although substantial benefit is derived from an adjustment pin and fixing pin that are not spring-biased. A hollow cylindrical spacer 54 may project from the sidewall through which the adjustment pin may pass before passing through the sidewall when it enters the receptacle body 12. The spacer helps reinforce the adjustment pin. The spacer may also be other shapes.

The opposing fixed support member 18 may also have substantially the same shape as the top wall 30 and moveable support member 16. The opposing fixed support member 18 has a top surface 18a, a bottom surface (not shown), a rear surface 18c adjoining the adjacent sidewalls and a substantially V-shaped opening 18d in the front thereof. The opposing fixed support member may be positioned in the lower portion 24 of the receptacle body 12 above or on the bottom wall 26 and substantially vertically aligned with the top wall 30 and spaced a sufficient distance below and opposite the moveable support member 16. The moveable support member 16 and the fixed member 18 cooperate to grip the pole-type member 14 at an upper and lower point respectively. The top wall 30 and fixed support member 18 may be integral with the adjoining sidewall 34.

Although the moveable support member is shown in the upper portion of the receptacle body 12 and the fixed support member in the lower portion of the receptacle body 12, it is to be appreciated that the moveable support member may alternatively be positioned in the lower portion and the fixed support member in the upper portion.

Referring now to FIGS. 1-9, in a preferred embodiment, the base member 22 comprises a first substantially L-shaped leg 56 having an elongated horizontal portion 58 and a vertical portion 60. The horizontal portion 58 has a first end and a second end 62 and 64. The first end 62 is coupled to the bottom surface (not shown) of the lower portion of the receptacle body 12 and extends longitudinally away from receptacle body 12. The second end 64 is coupled to the vertical portion 60. The base member 22 also comprises a second substantially L-shaped leg 66 having an elongated horizontal portion 68 and a vertical portion 70. The horizontal portion 68 has a first end 72 and a second end 74. The first end 72 is coupled to the bottom surface (not shown) of the lower portion of the receptacle body 12 and extends longitudinally away from the receptacle body 12. The second end 74 is coupled to the vertical portion 70.

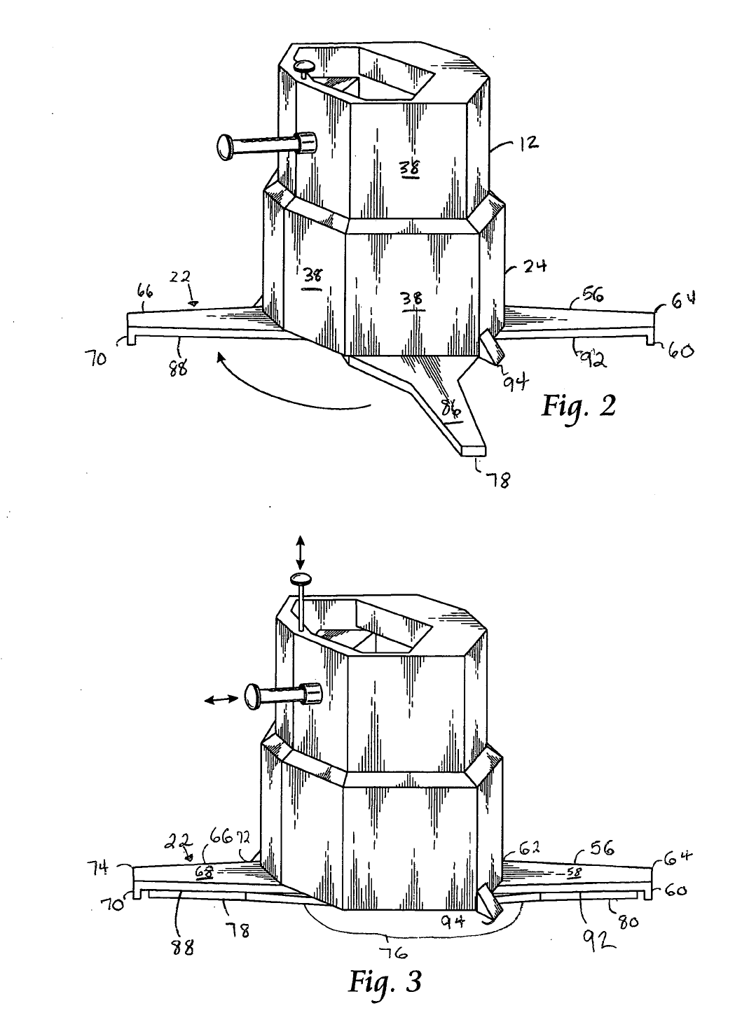

The base member 22 further comprises a stabilizing brace 76 having a first end and a second end 78 and 80. The stabilizing brace 76 is rotatably coupled by a bolt 82 and nut 84 to the bottom surface (not shown) of the receptacle body 12. The stabilizing brace 76 has a thickness less than the length of the vertical portions 60 and 70 of the first and second substantially L-shaped legs 56 and 66. The stabilizing brace 76 is dimensioned to be rotated to an open position (FIGS. 2, 4, 6 and 7) wherein the first end 78 of the stabilizing brace is at a substantially ninety degree angle to both the first substantially L-shaped leg 56 and the second substantially L-shaped leg 66 (See FIG. 2). In the open position, the second end 80 of the stabilizing brace is also at a substantially ninety degree angle to both the first substantially L-shaped leg 56 and the second substantially L-shaped leg 66. In the open position, the stabilizing brace 76 provides the pole-type member support device with greater stability in supporting a pole, tree, or other pole-type member. The stabilizing brace 76 is also preferably dimensioned to be rotated to a closed position (See FIG. 3) wherein a top surface 86 of the first end of the stabilizing brace is proximate a bottom surface 88 of the horizontal portion of the second substantially L-shaped leg 66, and a top surface 90 of the second end of the stabilizing brace is proximate a bottom surface 92 of the horizontal portion of the first substantially L-shaped leg 56.

The base member 22 may further comprise a first stop member 94 coupled to the lower end of a sidewall between the first substantially L-shaped leg 56 and the first end of the stabilizing brace 78. The base of the first stop member 94 may be aligned with the bottom of the vertical portion 60. The first stop member 94 is dimensioned to prevent the first end of the stabilizing brace 78 from rotating toward the first substantially L-shaped leg 56. A second stop member 95 may be coupled to an opposite side of the lower portion of the receptacle body between the second substantially L-shaped leg 66 and the second end of the stabilizing brace 80. The base of the second stop member 95 may be aligned with the bottom of the vertical portion 70. The second stop member may be dimensioned to prevent the second end of the stabilizing brace from rotating toward the second substantially L-shaped leg. While, in the preferred embodiment, the base member comprises a first stop member and a second stop member, it should be clearly understood that substantial benefit could be derived from an alternative configuration of the device which lacks stop members altogether or provides for an alternative mechanism for the prevention of free rotation of the support brace, such as an insertable pin or a high coefficient of friction or the like.

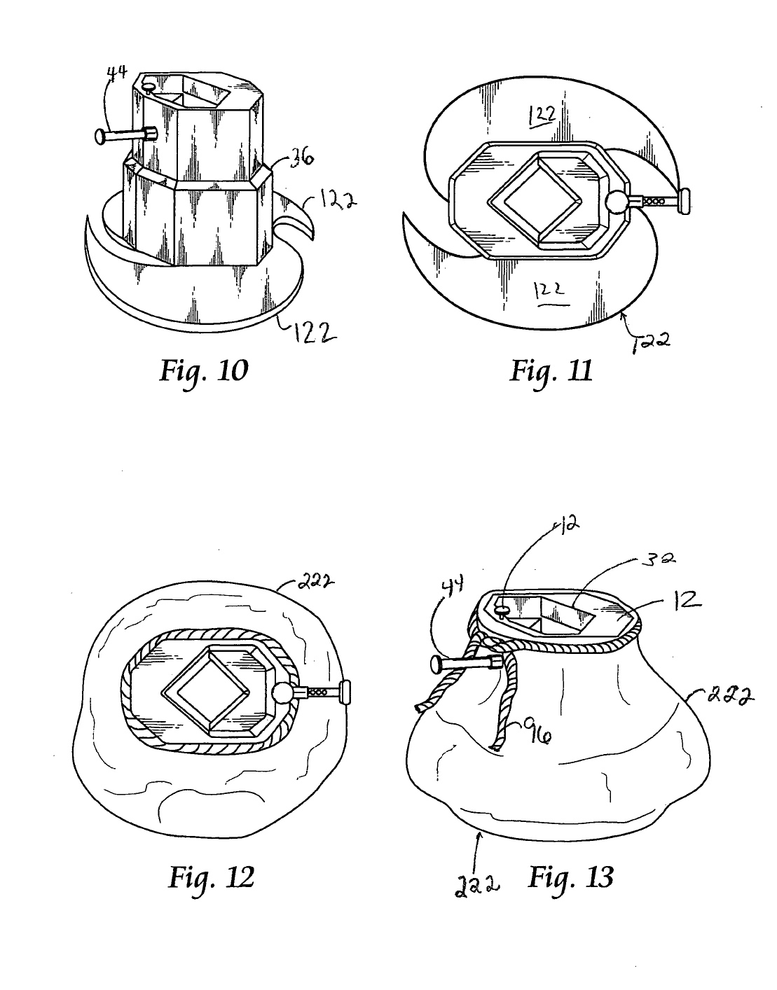

Referring now to FIGS. 10-11, an alternative embodiment of the pole-type member support device is disclosed. The receptacle body 12 is substantially the same as before, although the base member comprises an S-shaped base member 122 coupled to the bottom surface of the receptacle body 12. The base member may be constructed of a strong material to provide additional support.

Referring now to FIGS. 12-13, an alternative embodiment of the pole-type member support device is disclosed. The receptacle body 12 is substantially the same as before, although the base member comprises a substantially shell 222 resembling a Santa sack which encases the receptacle body. A piece of rope 96 may be tied around the top of the device to further resemble the Santa sack. Alternatively, a rope design may be engraved into the mold of the Santa sack. The shell may be made from a plastic material that stretches around the receptacle body.

In use, the moveable support member 16 may be moved horizontally to a position where its rear surface 16b abuts the inside surface of the adjacent sidewall panels with the fixing pin 42 in the aperture farthest from the adjustment pin knob 50 in order to accommodate a thicker pole-type member 14. The moveable support member 16 may be moved inwardly away from the sidewall 34 to accommodate a tree having a smaller diameter trunk. The moveable support member may be moved inwardly until the lower portion of the tree trunk is forced against the opposing fixed support member 18 and then fixed into position by repositioning the fixing pin 42 in the aperture 46 to hold the pole-type member 14 in an upright position.

From the foregoing, it is to be appreciated that these improved pole-type member support devices of the present invention provide maximum stabilization to hold the pole-type member in an upright position, while being easy to use. It is also to be appreciated that pole-type members of varying thickness may be held securely upright. In the case of trees, the ability of these pole-type member support devices to contain water help increase the moisture and longevity of the trees stabilized therein.

Although a particular embodiment of the invention has been described in detail for purposes of illustration, various modifications may be made without departing from the spirit and scope of the invention. Accordingly, the invention is not to be limited, except as by the appended claims.

We claim:

1. A pole-type member support device for securing pole-type members of varying thickness in an upright position, comprising:
a molded hollow receptacle body adapted to receive a portion of a pole-type member;
a moveable support member and a spaced-apart opposing fixed support member within the molded hollow receptacle body for cooperatively holding the pole-type member upright in the receptacle body; and
an adjustment assembly for positioning the moveable support member to accommodate pole-type members of varying thickness.

2. The pole-type member support device of claim 1, wherein the molded receptacle body comprises an upper portion having a substantially C-shaped top wall defining an opening for receiving the pole-type member, a lower portion having a bottom wall, and a multi-sided sidewall extending between the top and bottom walls with a beveled lip providing a transition surface between the upper and lower portions of the receptacle body.

3. The pole-type member support device of claim 1, wherein said adjustment assembly comprises an adjustment pin with a plurality of apertures provided in a top surface thereof defining different positions for the moveable support member, and a fixing pin adapted to be inserted into the desired aperture to position the moveable support member in the desired position.

4. The pole-type member support device of claim 3, wherein the moveable support member and the opposing fixed support member are substantially C-shaped having a multi-sided rear surface proximate the multi-sided sidewall and a substantially V-shaped front opening, the adjustment pin extending rearwardly from the moveable support member through the adjacent sidewall and adapted to move the moveable support member horizontally.

5. The pole-type member support device of claim 1, wherein the molded hollow receptacle body is dimensioned to contain water.

6. The pole-type member support device of claim 1, further comprising a base member, the base member comprised of:
a first substantially L-shaped leg having an elongated horizontal portion and a vertical portion, said horizontal portion has a first end coupled to said bottom surface of the receptacle body and extending longitudinally away from said receptacle body and a second end coupled to said vertical portion;
a second substantially L-shaped leg having an elongated horizontal portion and a vertical portion, said horizontal portion has a first end coupled to bottom surface of said receptacle and extending longitudinally away from said receptacle body and a second end coupled to said vertical portion; and
a stabilizing brace having a first end and a second end and rotatably coupled to said bottom surface of said first and second substantially L-shaped legs and having a thickness less than a length of said vertical portion of said first and second substantially L-shaped legs, said stabilizing brace dimensioned to be rotated to an open position wherein said first end of said stabilizing brace is at a substantially ninety degree angle to both said first substantially L-shaped leg and said second substantially L-shaped leg and said end of said stabilizing race is at a substantially ninety degree angle to both said first substantially L-shaped leg and said second substantially L-shaped leg, said stabilizing brace is dimensioned to be rotated to a closed position wherein a top surface of said first end of said stabilizing brace is proximate a bottom surface of said horizontal portion of said second substantially L-shaped leg and a top surface of said second end of said stabilizing brace is proximate a bottom surface of said horizontal portion of said first substantially L-shaped leg.

7. The pole-type member support device of claim 6, further comprising:
a first stop member coupled to the bottom end of a sidewall between the first substantially L-shaped leg and the first end of the stabilizing brace and dimensioned to prevent said first end of said stabilizing brace from rotating toward said first substantially L-shaped leg; and
a second stop member coupled to the opposite sidewall between the second substantially L-shaped leg and the second end of the stabilizing brace and dimensioned to prevent the second end of the stabilizing brace from rotating toward the second substantially L-shaped leg.

8. The pole-type member support of claim 1, further comprising a substantially S-shaped base member coupled to a bottom surface of the molded hollow receptacle body.

9. The pole-type member support of claim 1, further comprising a base member comprised of a decorative substantially shell encasing the receptacle body.

10. A pole-type member support device, comprising:
a molded hollow receptable body having an upper portion having a substantially C-shaped top wall defining an opening therein for receiving a portion of a pole-type member, a lower portion having a bottom wall, and a multi-sided sidewall extending between the top wall and the bottom wall,
a substantially C-shaped horizontally moveable support member and a cooperating opposing substantially C-shaped fixed support member within the molded hollow receptacle body, said substantially C-shaped support members having a multi-sided rear surface proximate the multi-sided sidewall and a substantially V-shaped front opening; and
an adjustment pin extending rearwardly from the moveable support member through the adjacent sidewall, the adjustment pin having a plurality of apertures provided in a top surface thereof defining different positions for the moveable support member, and a fixing pin extending vertically in the adjacent sidewall and adapted to be inserted into the desired aperture to position the moveable support member in the desired position to grip said pole-type member in said substantially V-shaped openings of said moveable support member and said fixed support member.

11. The pole-type member support device of claim 10, wherein a beveled lip provides a transition surface between the upper and lower portions of the molded hollow receptacle body.

12. The pole-type member support device of claim 10, wherein the molded hollow receptacle body is dimensioned to contain water.

13. The pole-type member support device of claim 10, further comprising a base member comprised of:
a first substantially L-shaped leg having an elongated horizontal portion and a vertical portion, said horizontal portion has a first end coupled to said bottom surface of the receptacle body and extending longitudinally away from said receptacle body and a second end coupled to said vertical portion;
a second substantially L-shaped leg having an elongated horizontal portion and a vertical portion, said horizontal portion has a first end coupled to bottom surface of said receptacle and extending longitudinally away from said receptacle body and a second end coupled to said vertical portion; and
a stabilizing brace having a first end and a second end and rotatably coupled to said bottom surface of said first and second substantially L-shaped legs and having a thickness less than a length of said vertical portion of said first and second substantially L-shaped legs, said stabilizing brace dimensioned to be rotated to an open position wherein said first end of said stabilizing brace is at a substantially ninety degree angle to both said first substantially L-shaped leg and said second substantially L-shaped leg and said second end of said stabilizing brace is at a substantially ninety degree angle to both said first substantially L-shaped leg and said second substantially L-shaped leg, said stabilizing brace is dimensioned to be rotated to a closed position wherein a top surface of said first end of said stabilizing brace is proximate a bottom surface of said horizontal portion of said second substantially L-shaped leg and a top surface of said second end of said stabilizing brace is proximate a bottom surface of said horizontal portion of said first substantially L-shaped leg.

14. The pole-type member support device of claim 13, further comprising:
a first stop member coupled to the bottom end of a sidewall between the first substantially L-shaped leg and the first end of the stabilizing brace and dimensioned to prevent said first end of said stabilizing brace from rotating toward said first substantially L-shaped leg; and
a second stop member coupled to the opposite sidewall between the second substantially L-shaped leg and the second end of the stabilizing brace and dimensioned to prevent the second end of the stabilizing brace from rotating toward the second substantially L-shaped leg.

15. The pole-type member support of claim 10, further comprising a substantially S-shaped base member coupled to a bottom surface of the molded hollow receptacle body.

16. The pole-type member support of claim 10, further comprising a base member comprised of a shell encasing the molded hollow receptacle body.

17. A method for supporting a pole-type member in a pole-type member support device, comprising, in combination, the steps of:
providing a molded hollow receptacle body having an upper portion with a substantially C-shaped top wall defining an opening therein for receiving the pole-type member and a lower portion with a bottom wall and a multi-sided sidewall extending between the top wall and the bottom wall and a substantially C-shaped moveable support member inside the upper portion and a substantially C-shaped fixed support member in the lower portion opposite the moveable support member and vertically aligned with the substantially C-shaped top wall, an adjustment pin extending through the multi-sided sidewall from a rear surface of said substantially C-shaped moveable support and having a plurality of apertures provided in a top surface thereof for defining different positions for the moveable support member, and a fixing pin extending vertically in the sidewall and adapted to be inserted into the desired aperture to position the moveable support member in the desired position;
inserting said bottom portion of said pole-type member into said opening in said top wall of said receptacle body until it substantially reaches the bottom wall of the receptacle body;
horizontally adjusting said moveable support member by moving the moveable support member away from the multi-sided sidewall toward the center of the receptacle body until a position where the substantially V-shaped openings at the front of the top wall, the moveable support member, and the fixed support member each grip a portion of the pole-type member; and
fixing said moveable support member in said position by inserting said fixing pin into the selected aperture in said adjustment pin to hold said pole-type member in an upright position.

18. The method of claim 17, wherein a base member supports the molded hollow receptacle body and comprises a first substantially L-shaped leg having an elongated horizontal portion and a vertical portion, said horizontal portion has a first end coupled to said bottom surface of the receptacle body and extending longitudinally away from said receptacle body and a second end coupled to said vertical portion;
a second substantially L-shaped leg having an elongated horizontal portion and a vertical portion, said horizontal portion has a first end coupled to bottom surface of said receptacle and extending longitudinally away from said receptacle body and a second end coupled to said vertical portion; and
a stabilizing brace having a first end and a second end and rotatably coupled to said bottom surface of said first and second substantially L-shaped legs and having a thickness less than a length of said vertical portion of said first and second substantially L-shaped legs, said stabilizing brace dimensioned to be rotated to an open position wherein said first end of said stabilizing brace is at a substantially ninety degree angle to both said first substantially L-shaped leg and said second substantially L-shaped leg and said second end of said stabilizing brace is at a substantially ninety degree angle to both said first substantially L-shaped leg and said second substantially L-shaped leg, said stabilizing brace is dimensioned to be rotated to a closed position wherein a top surface of said first end of said stabilizing brace is proximate a bottom surface of said horizontal portion of said second substantially L-shaped leg and a top surface of said second end of said stabilizing brace is proximate a bottom surface of said horizontal portion of said first substantially L-shaped leg.

19. The pole-type member support device of claim 18, further comprising:
a first stop member coupled to the bottom end of a sidewall between the first substantially L-shaped leg and the first end of the stabilizing brace and dimensioned to prevent said first end of said stabilizing brace from rotating toward said first substantially L-shaped leg; and
a second stop member coupled to the opposite sidewall between the second substantially L-shaped leg and the second end of the stabilizing brace and dimensioned to prevent the second end of the stabilizing brace from rotating toward the second substantially L-shaped leg.

20. The method of claim 17, wherein the pole-type member comprises a cut Christmas tree trunk
